(19) United States
(12) Patent Application Publication
(10) Pub. No.: US 2026/0362093 A1
(43) Pub. Date: Nov. 12, 2026

(54) METHODS AND APPARATUSES FOR V2X APPLICATION

(71) Applicant: Telefonaktiebolaget LM Ericsson (publ), Stockholm (SE)

(72) Inventor: Fengpei ZHANG, Guangzhou (CN)

(21) Appl. No.: 19/135,125

(22) PCT Filed: Dec. 7, 2022
(86) PCT No.: PCT/CN2022/137272

§ 371 Date: Jun. 3, 2025

(51) Int. Cl. H04W 4/20; H04W 4/021; H04W 4/40

(52) U.S. Cl. CPC H04W 4/20; H04W 4/021; H04W 4/40

(57) ABSTRACT

Methods and apparatuses for vehicle-to-everything (V2X) application are disclosed. According to an embodiment, a V2X application specific server (VASS) receives, from a terminal device, a first indication indicating that a battery level of the terminal device is lower than a predetermined threshold. The VASS determines whether the terminal device is entering a vulnerable road user (VRU) zone. When determining that the terminal device is entering a VRU zone, the VASS obtains a location of the terminal device from a service enabler architecture layer (SEAL) location management service (LMS). The VASS sends, via a V2X application enabler (VAE) server to one or more neighbor terminal devices which are neighboring to the terminal device, an alert message indicating that the terminal device with the battery level lower than the predetermined threshold is around the obtained location.

### TECHNICAL FIELD

Embodiments of the disclosure generally relate to communication, and, more particularly, to methods and apparatuses for vehicle-to-everything (V2X) application.

### BACKGROUND

This section introduces aspects that may facilitate better understanding of the present disclosure. Accordingly, the statements of this section are to be read in this light and are not to be understood as admissions about what is in the prior art or what is not in the prior art.

V2X is a technology that allows vehicles to communicate with any entity that may affect the vehicle, and vice versa. V2X consists of more specific types of communication such as vehicle-to-infrastructure (V2I), vehicle-to-network (V2N), vehicle-to-vehicle (V2V), vehicle-to-pedestrian (V2P), etc.

Cellular vehicle-to-everything (C-V2X) allows a C-V2X device to use the cellular network connection in the traditional manner over Uu interface. Uu refers to the logical interface between a user equipment (UE) and a base station. This is generally referred to V2N.

However, due to the huge amount of message exchanges especially for V2V communication, the 3rd generation partnership project (3GPP) also introduces PC5 interface (also known as “slidelink” in 3GPP radio access network (RAN) specification) to support direct communication between C-V2X devices to improve the C-V2X efficiency.

V2X is also essential for safe and efficient autonomous driving. For example, V2X communication can alert an autonomous driving vehicle about objects it cannot directly see (non-line-of-sight).

FIG. 1 illustrates a reference architecture of C-V2X. As shown, pedestrians 110, vehicles 120 and road side units (RSUs) 130 may communicate with each other over PC5 interface. The RSUs 130 may communicate, over Uu interface, with evolved packet core (EPC)/5th generation core (5GC) 140, which in turn communicates with V2X application servers 150.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for V2X application. In particular, one of the problems to be solved by the disclosure is that the existing solution for pedestrian protection may cause a pedestrian UE with a low battery level to run out of the battery quickly thereby losing the protection provided by pedestrian safety system.

According to a first aspect of the disclosure, there is provided a method performed by a V2X application specific server (VASS). The method may comprise receiving, from a terminal device, a first indication indicating that a battery level of the terminal device is lower than a predetermined threshold. The method may further comprise determining whether the terminal device is entering a vulnerable road user (VRU) zone. The method may further comprise, when determining that the terminal device is entering a VRU zone, obtaining a location of the terminal device from a service enabler architecture layer (SEAL) location management service (LMS). The method may further comprise sending, via a V2X application enabler (VAE) server to one or more neighbor terminal devices which are neighboring to the terminal device, an alert message indicating that the terminal device with the battery level lower than the predetermined threshold is around the obtained location.

In this way, it is possible to prolong the time of duration of protection provided to an entity carrying the terminal device even though the terminal device has a low battery level.

In an embodiment of the disclosure, the alert message may comprise: information about the terminal device; a second indication indicating that the battery level of the terminal device is lower than the predetermined threshold; and information about the obtained location of the terminal device.

In an embodiment of the disclosure, the first indication may be received in an application context for the terminal device.

In an embodiment of the disclosure, the first indication may be implemented by an indicator having a first value. The indicator can take the first value for indicating that the battery level of the terminal device is lower than the predetermined threshold, or a second value for indicating that the battery level of the terminal device is not lower than the predetermined threshold.

In an embodiment of the disclosure, the second indication may be implemented by an indicator having a first value. The indicator can take the first value for indicating that the battery level of the terminal device is lower than the predetermined threshold, or a second value for indicating that the battery level of the terminal device is not lower than the predetermined threshold.

In an embodiment of the disclosure, determining whether the terminal device is entering a VRU zone may comprise sending, to the VAE server, a first request for subscribing to a notification related to whether the terminal device is entering or leaving a VRU zone. Determining whether the terminal device is entering a VRU zone may further comprise receiving the notification from the VAE server.

In an embodiment of the disclosure, obtaining the location of the terminal device from the SEAL LMS may comprise sending, to the SEAL LMS, a second request for tracking the location of the terminal device. Obtaining the location of the terminal device from the SEAL LMS may further comprise receiving, from the SEAL LMS, the location of the terminal device.

In an embodiment of the disclosure, the method may further comprise receiving, from the terminal device, a third indication indicating that the battery level of the terminal device is not lower than the predetermined threshold. The method may further comprise stopping the obtaining of the location of the terminal device and the sending of the alert message.

In an embodiment of the disclosure, the third indication may be implemented by an indicator having a second value. The indicator can take a first value for indicating that the battery level of the terminal device is lower than the predetermined threshold, or the second value for indicating that the battery level of the terminal device is not lower than the predetermined threshold.

According to a second aspect of the disclosure, there is provided a method performed by a terminal device. The method may comprise, when a battery level of the terminal device is lower than a predetermined threshold, sending, to a VASS, a first indication indicating that the battery level of the terminal device is lower than the predetermined threshold. The method may further comprise entering an idle mode where one or more predetermined operations related to vehicle-to-pedestrian (V2P) application are prohibited.

In this way, it is possible to minimize the power consumption of the terminal device with a low battery level to allow the terminal device to prolong the time of duration of keeping a connection with its serving network so as to prolong the time of duration of ing protected by pedestrian safety system.

In an embodiment of the disclosure, the one or more predetermined operations related to V2P application may comprise at least one of: sending/receiving V2X messages; processing V2X messages; and retrieving and sending a global positioning system (GPS) location of the terminal device to a SEAL LMS.

In an embodiment of the disclosure, the first indication may be sent in an application context for the terminal device.

In an embodiment of the disclosure, the first indication may be implemented by an indicator having a first value. The indicator can take the first value for indicating that the battery level of the terminal device is lower than the predetermined threshold, or a second value for indicating that the battery level of the terminal device is not lower than the predetermined threshold.

In an embodiment of the disclosure, the method may further comprise, when the battery level of the terminal device is not lower than the predetermined threshold, sending, to the VASS, a second indication indicating that the battery level of the terminal device is not lower than the predetermined threshold. The method may further comprise entering a normal mode where the one or more predetermined operations related to V2P application are performed as normal.

In an embodiment of the disclosure, the second indication may be implemented by an indicator having a second value. The indicator can take a first value for indicating that the battery level of the terminal device is lower than the predetermined threshold, or the second value for indicating that the battery level of the terminal device is not lower than the predetermined threshold.

According to a third aspect of the disclosure, there is provided a method performed by a VAE server. The method may comprise receiving, from a VASS, an alert message indicating that a terminal device with a battery level lower than a predetermined threshold is around a location, and information about a geographical area in which the alert message is to be distributed. The method may further comprise forwarding the alert message to one or more neighbor terminal devices which are neighboring to the terminal device in the geographical area, based on the information about the geographical area.

In this way, it is possible to provide protection to an entity carrying the terminal device even though the terminal device has a low battery level.

In an embodiment of the disclosure, the alert message may comprise: information about the terminal device; an indication indicating that the battery level of the terminal device is lower than the predetermined threshold; and information about the location of the terminal device.

In an embodiment of the disclosure, the indication may be implemented by an indicator having a first value. The indicator can take the first value for indicating that the battery level of the terminal device is lower than the predetermined threshold, or a second value for indicating that the battery level of the terminal device is not lower than the predetermined threshold.

According to a fourth aspect of the disclosure, there is provided a method performed by a first terminal device. The method may comprise receiving, from a VAE server, an alert message indicating that a second terminal device with a battery level lower than a predetermined threshold is around a location. The method may further comprise performing one or more predetermined operations for enhancing protection of an entity carrying the second terminal device, based on the alert message.

In this way, it is possible to provide protection to an entity carrying the second terminal device even though the second terminal device has a low battery level.

In an embodiment of the disclosure, the one or more predetermined operations may comprise one or more of: detecting, around the location indicated by the alert message, a more accurate location of the second terminal device; causing a vehicle carrying the first terminal device to honk when the vehicle is traveling around the location; and causing a vehicle carrying the first terminal device to keep a predetermined distance with the location.

In an embodiment of the disclosure, the more accurate location of the second terminal device may be detected by one or more of: a radar; a lidar; and a video camera.

In an embodiment of the disclosure, the alert message may comprise: information about the second terminal device; an indication indicating that the battery level of the second terminal device is lower than the predetermined threshold; and information about the location of the second terminal device.

According to a fifth aspect of the disclosure, there is provided a VASS. The VASS may comprise at least one processor and at least one memory. The at least one memory may contain instructions executable by the at least one processor, whereby the VASS may be operative to receive, from a terminal device, a first indication indicating that a battery level of the terminal device is lower than a predetermined threshold. The VASS may be further operative to determine whether the terminal device is entering a VRU zone. The VASS may be further operative to, when determining that the terminal device is entering a VRU zone, obtain a location of the terminal device from a SEAL LMS. The VASS may be further operative to send, via a VAE server to one or more neighbor terminal devices which are neighboring to the terminal device, an alert message indicating that the terminal device with the battery level lower than the predetermined threshold is around the obtained location.

In an embodiment of the disclosure, the VASS may be operative to perform the method according to the above first aspect.

According to a sixth aspect of the disclosure, there is provided a terminal device. The terminal device may comprise at least one processor and at least one memory. The at least one memory may contain instructions executable by the at least one processor, whereby the terminal device may be operative to, when a battery level of the terminal device is lower than a predetermined threshold, send, to a VASS, a first indication indicating that the battery level of the terminal device is lower than the predetermined threshold. The terminal device may be further operative to enter an idle mode where one or more predetermined operations related to V2P application are prohibited.

In an embodiment of the disclosure, the terminal device may be operative to perform the method according to the above second aspect.

According to a seventh aspect of the disclosure, there is provided a VAE server. The VAE server may comprise at least one processor and at least one memory. The at least one memory may contain instructions executable by the at least one processor, whereby the VAE server may be operative to receive, from a VASS, an alert message indicating that a terminal device with a battery level lower than a predetermined threshold is around a location, and information about a geographical area in which the alert message is to be distributed. The VAE server may be further operative to forward the alert message to one or more neighbor terminal devices which are neighboring to the terminal device in the geographical area, based on the information about the geographical area.

In an embodiment of the disclosure, the VAE server may be operative to perform the method according to the above third aspect.

According to an eighth aspect of the disclosure, there is provided a first terminal device. The first terminal device may comprise at least one processor and at least one memory. The at least one memory may contain instructions executable by the at least one processor, whereby the first terminal device may be operative to receive, from a VAE server, an alert message indicating that a second terminal device with a battery level lower than a predetermined threshold is around a location. The first terminal device may be further operative to perform one or more predetermined operations for enhancing protection of an entity carrying the second terminal device, based on the alert message.

In an embodiment of the disclosure, the first terminal device may be operative to perform the method according to the above fourth aspect.

According to a ninth aspect of the disclosure, there is provided a computer program product. The computer program product may comprise instructions which when executed by at least one processor, cause the at least one processor to perform the method according to any of the above first to fourth aspects.

According to a tenth aspect of the disclosure, there is provided a computer readable storage medium. The computer readable storage medium may store thereon instructions which when executed by at least one processor, cause the at least one processor to perform the method according to any of the above first to fourth aspects.

According to an eleventh aspect of the disclosure, there is provided a VASS. The VASS may comprise a reception module for receiving, from a terminal device, a first indication indicating that a battery level of the terminal device is lower than a predetermined threshold. The VASS may further comprise a determination module for determining whether the terminal device is entering a VRU zone. The VASS may further comprise an obtaining module for, when determining that the terminal device is entering a VRU zone, obtaining a location of the terminal device from a SEAL LMS. The VASS may further comprise a sending module for sending, via a VAE server to one or more neighbor terminal devices which are neighboring to the terminal device, an alert message indicating that the terminal device with the battery level lower than the predetermined threshold is around the obtained location.

According to a twelfth aspect of the disclosure, there is provided a terminal device. The terminal device may comprise a sending module for, when a battery level of the terminal device is lower than a predetermined threshold, sending, to a VASS, a first indication indicating that the battery level of the terminal device is lower than the predetermined threshold. The terminal device may further comprise a control module for entering an idle mode where one or more predetermined operations related to V2P application are prohibited.

According to a thirteenth aspect of the disclosure, there is provided a VAE server. The VAE server may comprise a reception module for receiving, from a VASS, an alert message indicating that a terminal device with a battery level lower than a predetermined threshold is around a location, and information about a geographical area in which the alert message is to be distributed. The VAE server may further comprise a forwarding module for forwarding the alert message to one or more neighbor terminal devices which are neighboring to the terminal device in the geographical area, based on the information about the geographical area.

According to a fourteenth aspect of the disclosure, there is provided a first terminal device. The first terminal device may comprise a reception module for receiving, from a VAE server, an alert message indicating that a second terminal device with a battery level lower than a predetermined threshold is around a location. The first terminal device may further comprise a performing module for performing one or more predetermined operations for enhancing protection of an entity carrying the second terminal device, based on the alert message.

According to a fifteenth aspect of the disclosure, there is provided a method implemented in a communication system including two or more of a VASS, a terminal device, a VAE server and a first terminal device. The method may comprise steps of two or more of the methods according to the above first to fourth aspects.

According to a sixteenth aspect of the disclosure, there is provided a communication system including two or more of a VASS according to the above fifth or eleventh aspect, a terminal device according to the above sixth or twelfth aspect, a VAE server according to the above seventh or thirteenth aspect, and a first terminal device according to the above eighth or fourteenth aspect.

With some embodiment(s) of the disclosure, since the terminal device with a low battery level offloads V2X message processing to the VASS, the battery consumption of the terminal device can be minimized so that its network connection can be maintained as long as possible (or the time of duration of its network connection can be prolonged). As long as the terminal device is connected, the VASS can subscribe to its network locations and alert its neighbor terminal device(s) to pay attention to its presence (or to take special action to protect the entity carrying the terminal device). In this way, it is possible to provide protection to the entity carrying the terminal device as long as possible (or to prolong the time of duration of the protection provided to the entity carrying the terminal device) even though the terminal device has a low battery level.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a reference architecture of C-V2X;

FIG. 2 is a diagram illustrating a process for VAE client enabled V2P communication schedule configuration;

FIG. 3 is a diagram illustrating a process for VAE server enabled V2P communication schedule configuration;

FIG. 4 is a diagram illustrating an exemplary communication system into which an embodiment of the disclosure is applicable;

FIG. 5 is a flowchart illustrating a method performed by a VASS according to an embodiment of the disclosure;

FIG. 6 is a flowchart for explaining the method of FIG. 5;

FIG. 7 is a flowchart for explaining the method of FIG. 5;

FIG. 8 is a flowchart illustrating a method performed by a VASS according to an embodiment of the disclosure;

FIG. 9 is a flowchart illustrating a method performed by a terminal device according to an embodiment of the disclosure;

FIG. 10 is a flowchart illustrating a method performed by a terminal device according to an embodiment of the disclosure;

FIG. 11 is a flowchart illustrating a method performed by a VAE server according to an embodiment of the disclosure;

FIG. 12 is a flowchart illustrating a method performed by a first terminal device according to an embodiment of the disclosure;

FIG. 13 is a flowchart illustrating an exemplary process according to an embodiment of the disclosure;

FIG. 14 is a flowchart illustrating an exemplary process according to an embodiment of the disclosure;

FIG. 15 is a block diagram showing an apparatus suitable for use in practicing some embodiments of the disclosure;

FIG. 16 is a block diagram showing a VASS according to an embodiment of the disclosure;

FIG. 17 is a block diagram showing a terminal device according to an embodiment of the disclosure;

FIG. 18 is a block diagram showing a VAE server according to an embodiment of the disclosure; and

FIG. 19 is a block diagram showing a first terminal device according to an embodiment of the disclosure.

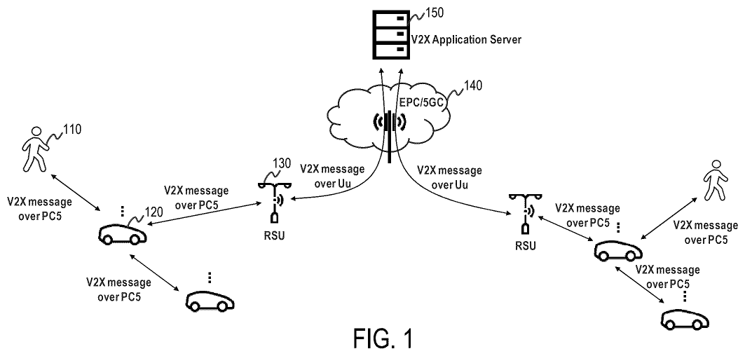

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Vehicle-to-pedestrian (V2P) operates under the same mechanism as other types of vehicle-to-everything (V2X) communications like vehicle-to-vehicle (V2V) and vehicle-to-infrastructure (V2I). However, we cannot simply install V2X connectivity units on unpowered V2P entities like bicycles, scooters, skateboards, wheelchairs, and of course, the human body. In this case, smartphones can act as end entities.

However, the limited battery life of smartphones is a bottleneck in realization of the pedestrian safety system. In 3GPP technical report (TR) 23.700-64 V1.0.0 (chapter 6.1), a solution is proposed for V2X application enabler (VAE) to support energy efficient V2P. The VAE layer may provide support functionality for enabling V2P applications, by consolidating the V2P application requirements and aligning the communication traffic pattern with the PC5 quality of service (QOS) setting and the access stratum (AS) layer configurations (e.g. discontinuous reception (DRX) cycles). Such alignment may be in the form of triggering the update of QoS/AS layer configuration based on application requirement.

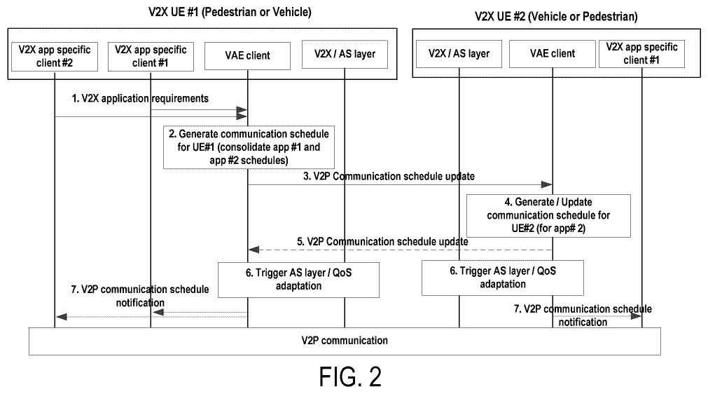

The different procedures correspond to different solution variants to address different use cases. FIG. 2 is FIG. 6.1.1.2.1-1 of 3GPP TR 23.700-64 V1.0.0 and provides a VAE-client enabled V2P communication schedule configuration, which could be applicable to off-network deployments and could be triggered by the application of the V2X user equipment (UE) (e.g. if UE battery drops while the V2P session is ongoing) based on prior configuration from the VAE server. At step 1, on V2X UE #1, the V2X application specific client 1 and 2 provide the V2X application requirements to the VAE client, including delay requirements, etc., for the PC5 communication. At step 2, V2X UE #1's VAE client consolidates requirements from both applications and generates a UE level transmission schedule, so that the off-duration is maximized. At step 3, V2X UE #1's VAE client sends a V2P communication schedule update message which includes the generated UE level transmission schedule to other VAE client 2 (in vicinity, or in service-based group), in order to negotiate the optimal transmission pattern or inform on the expected reception pattern. At step 4, V2X UE #2's VAE client either accepts or provides its transmission cycle or negotiates the traffic pattern. This depends on the relation between UEs as well as the priorities (e.g. UE-1 may be a group lead). At step 5, VAE clients of V2X UE #2 may optionally send a V2P communication schedule update message indicating the expected/generated UE #2 transmission pattern. At step 6, V2X UE #1's and V2X UE #2's VAE clients provide the updated traffic pattern as V2X Application Requirements to V2X layer, also including QoS requirements such as delay requirements, priority, etc., for the PC5 communication for both applications, as specified in 3GPP technical specification (TS) 23.287, clause 5.4.1.1. VAE client may also indicate the transmission mode (unicast, groupcast) per application. The V2X layer of UEs #1 and #2 process the requirements from VAE client and generates a UE level DRX schedule. The AS layer of UE #1 and #2 applies/configures the DRX schedule for the corresponding V2X communication. At step 7, VAE clients of V2X UEs #1 and #2 may send a notification to the V2X application specific client(s) to inform on the communication traffic pattern.

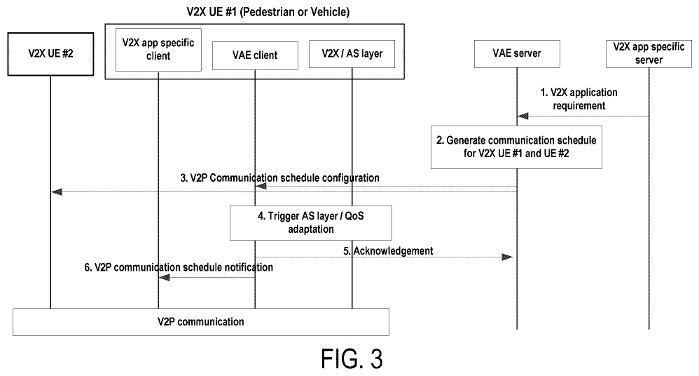

FIG. 3 is FIG. 6.1.1.2.2-1 of 3GPP TR 23.700-64 V1.0.0 and provides a VAE server enabled V2P communication schedule configuration, which could be applicable to use cases where the VAE server after receiving the V2X application specific server (VASS) requirement, configures/aligns the schedules for the V2X UEs (e.g. can be used within vulnerable road user (VRU) zones to avoid flooding/interference by continuous sending/receiving V2X messages). At step 1, one or more V2X application specific servers provide the V2X application requirements to the VAE server, including application QOS requirements for the V2P applications and provisioning policies and parameters for the PC5 communication. At step 2, the VAE server generates a communication schedule for one or more involved V2X UEs, so that the off duration is maximized. At step 3, the VAE server sends a V2P communication schedule configuration message to the involved VAE clients. At step 4, V2X UE #1's and V2X UE #2's VAE clients provide the updated traffic pattern as V2X Application Requirements to V2X layer, also including QoS requirements such as delay requirements, priority, etc., for the PC5 communication for both applications, as specified in 3GPP TS 23.287, clause 5.4.1.1. VAE client may also indicate the transmission mode (unicast, groupcast) per application. The V2X layer of UEs #1 and #2 process the requirements from VAE client and generates a UE level DRX schedule. The AS layer of UE #1 and #2 applies/configures the DRX schedule for the corresponding V2X communication. At step 5, VAE clients of V2X UEs #1 and #2 may send an acknowledgement to the VAE server. At step 6, VAE clients of V2X UEs #1 and #2 may send a notification to the V2X application specific client(s) to inform on the communication traffic pattern.

It can be seen that the philosophy of 3GPP solutions is to adjust the communication configuration of V2P UEs based on their context to minimize the battery consumption.

However, if a pedestrian UE inside a VRU zone is on a low battery level, keeping sending/receiving/processing V2X messages as usual will soon run out of the battery and further make the UE disconnect from the network. The VRU will completely lose the protection by the V2X system.

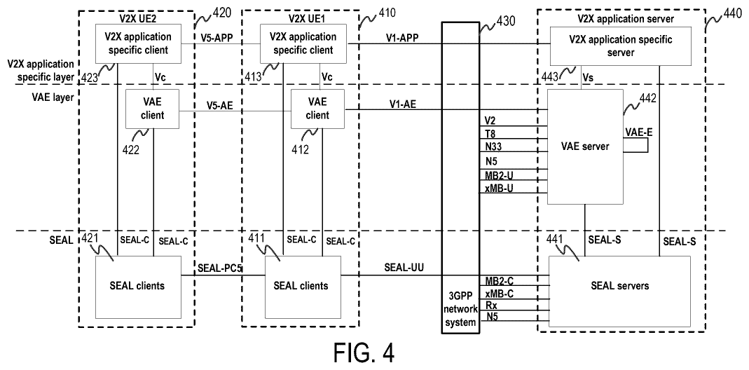

The present disclosure proposes an improved solution for V2X application. Hereinafter, the solution will be described in detail with reference to FIGS. 4-19.

FIG. 4 is a diagram illustrating an exemplary communication system into which an embodiment of the disclosure is applicable. As shown, the communication system comprises a V2X UE 410 (also marked as V2X UE1), a V2X UE 420 (also marked as V2X UE2), a 3GPP network system 430, and a V2X application server 440. The V2X UE 410 comprises service enabler architecture layer (SEAL) clients 411, a VAE client 412 and a V2X application specific client 413. The V2X UE 420 comprises SEAL clients 421, a VAE client 422 and a V2X application specific client 423. The SEAL client(s) 411/421 can provide SEAL services to the V2X application specific client 410/420 over SEAL-C reference point. The VAE client 412/422 can provide V2X application layer support functions to the V2X application specific client 413/423 over Vc reference point. The V2X application server 440 comprises SEAL servers 441, a VAE server 442, and a V2X application specific server 443. The SEAL server(s) 441 can provide SEAL services to the V2X application specific server 443 over SEAL-S reference point. The VAE server 442 can provide V2X application layer support functions to the V2X application specific server 443 over Vs reference point. Note that the number of the above mentioned entity may be one or more than one. Also note that the network function (or network entity) mentioned in this document may be implemented either as a network element on a dedicated hardware, as a software instance running on a dedicated hardware, or as a virtualized function instantiated on an appropriate platform, e.g. on a cloud infrastructure.

The V2X application layer functional entities for the V2X UE and the V2X application server are grouped into the V2X application specific layer and the VAE layer. The V2X application specific layer comprises V2X application specific functionalities. The VAE layer offers VAE capabilities to the V2X application specific layer. The VAE server is located in the VAE layer. The V2X application layer functional model utilizes the SEAL services as specified in 3GPP TS 23.434 V18.2.0. The SEAL services utilized by VAE layer comprise, but not limited to, location management, group management, configuration management, identity management, key management and network resource management, etc. More details of the communication system can be obtained from 3GPP TS 23.286 V17.4.0.

Within the context of this disclosure, the term UE or terminal device may also be referred to as, for example, device, access terminal, mobile station, mobile unit, subscriber station, or the like. It may refer to any end device that can access a wireless communication network and receive services therefrom. By way of example and not limitation, the UE or terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a UE or terminal device may represent a machine or other device that performs monitoring and/or measurements, and transmits the results of such monitoring and/or measurements to another UE or terminal device and/or a network equipment. In this case, the UE or terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

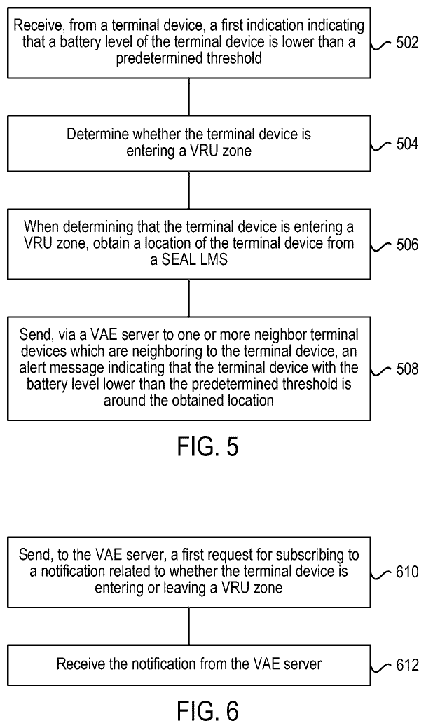

FIG. 5 is a flowchart illustrating a method performed by a VASS according to an embodiment of the disclosure. At block 502, the VASS receives, from a terminal device, a first indication indicating that a battery level of the terminal device is lower than a predetermined threshold. For example, the terminal device may be carried by a pedestrian. The first indication may be received in an application context for the terminal device. The first indication may be implemented by an indicator having a first value. The indicator can take the first value for indicating that the battery level of the terminal device is lower than the predetermined threshold, or a second value for indicating that the battery level of the terminal device is not lower than the predetermined threshold. Note that the first indication may be implemented in any other suitable way.

At block 504, the VASS determines whether the terminal device is entering a (VRU) zone. For example, block 504 may be implemented as blocks 610-612 of FIG. 6. At block 610, the VASS sends, to the VAE server, a first request for subscribing to a notification related to whether the terminal device is entering or leaving a VRU zone. For example, the first request may indicate a time period during which the notification is to be sent from the VAE server to the VASS as long as the terminal device enters or leaves a VRU zone. To protect the entity carrying the terminal device, the “VRU zone” mentioned here refers to any VRU zone and is not limited to a specific VRU zone. At block 612, the VASS receives the notification from the VAE server. For instance, blocks 610-612 may be implemented in a way similar to that described in section 6.2 of 3GPP TR 23.700-64 V1.0.0. If the notification indicates that the terminal device is entering a VRU zone, then the determination result at block 504 is positive. On the other hand, if the notification indicates that the terminal device is leaving a VRU zone, then the determination result at block 504 is negative.

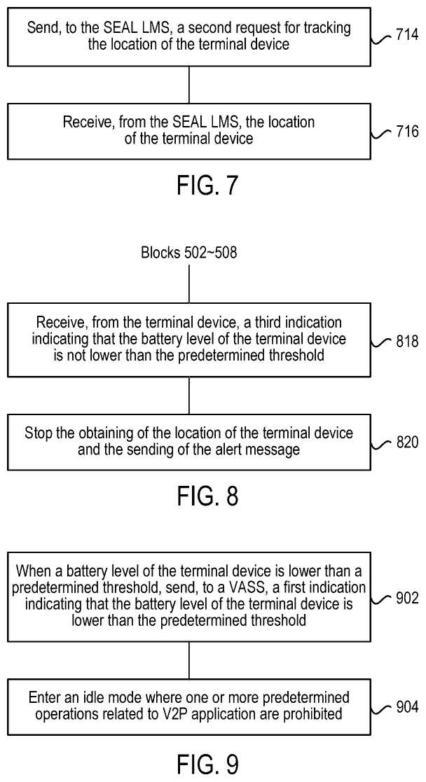

At block 506, when determining that the terminal device is entering a VRU zone, the VASS obtains a location of the terminal device from a SEAL location management service (LMS). For example, block 506 may be implemented as blocks 714-716 of FIG. 7. At block 714, the VASS sends, to the SEAL LMS, a second request for tracking the location of the terminal device. For example, the second request may indicate a time period during which the location of the terminal device is to be tracked. The second request may also indicate the time interval with which the tracked location of the terminal device is to be sent from the SEAL LMS to the VASS. At block 716, the VASS receives, from the SEAL LMS, the location of the terminal device. For instance, blocks 714-716 may be implemented in a way similar to that described in section 9.3.5 of 3GPP TS 23.434 V18.2.0.

At block 508, the VASS sends, via a VAE server to one or more neighbor terminal devices which are neighboring to the terminal device, an alert message indicating that the terminal device with the battery level lower than the predetermined threshold is around the obtained location. For example, the VASS may send, to the VAE server, the alert message and information about a geographical area in which the alert message is to be distributed. The alert message may comprise: information (e.g. identification information) about the terminal device; a second indication indicating that the battery level of the terminal device is lower than the predetermined threshold; and information about the obtained location of the terminal device. Similarly to the first indication, the second indication may be implemented by an indicator having a first value. The indicator can take the first value for indicating that the battery level of the terminal device is lower than the predetermined threshold, or a second value for indicating that the battery level of the terminal device is not lower than the predetermined threshold. Note that the second indication may be implemented in any other suitable way.

Since the location of the terminal device obtained from the SEAL LMS may not be very accurate and the frequency of obtaining the location may not be very high, the geographical area may cover a predetermined range around the obtained location so that vehicle(s) in the geographical area need to pay special attention to the terminal device. The one or more neighbor terminal devices may be the terminal device(s) carried by the vehicle(s) in the geographical area. Then, the VAE server may send the alert message to the one or more neighbor terminal devices based on the information about the geographical area. The way in which the alert message is sent from the VASS to the one or more neighbor terminal devices may be similar to that described in section 9.4 of 3GPP TS 23.286 V17.4.0.

With the method of FIG. 5, since the alert message is sent by the VASS on behalf of the terminal device, it is possible to prolong the time of duration of protection provided to an entity carrying the terminal device even though the terminal device has a low battery level.

FIG. 8 is a flowchart illustrating a method performed by a VASS according to an embodiment of the disclosure. As shown, the method comprises blocks 502-508 and blocks 818-820. Blocks 502-508 have been described above and their details are omitted here for brevity. At block 818, the VASS receives, from the terminal device, a third indication indicating that the battery level of the terminal device is not lower than the predetermined threshold. For example, the third indication may be implemented by an indicator having a second value. The indicator can take a first value for indicating that the battery level of the terminal device is lower than the predetermined threshold, or the second value for indicating that the battery level of the terminal device is not lower than the predetermined threshold. Note that the third indication may be implemented in any other suitable way. At block 820, the VASS stops the obtaining of the location of the terminal device and the sending of the alert message. With the method of FIG. 8, more reliable protection can be provided to the terminal device in a case where the battery level of the terminal device is recovered to be normal.

FIG. 9 is a flowchart illustrating a method performed by a terminal device according to an embodiment of the disclosure. For example, the terminal device may be carried by a pedestrian. At block 902, when a battery level of the terminal device is lower than a predetermined threshold, the terminal device sends, to a VASS, a first indication indicating that the battery level of the terminal device is lower than the predetermined threshold. For example, the first indication may be sent in an application context for the terminal device. The first indication may be implemented by an indicator having a first value. The indicator can take the first value for indicating that the battery level of the terminal device is lower than the predetermined threshold, or a second value for indicating that the battery level of the terminal device is not lower than the predetermined threshold.

At block 904, the terminal device enters an idle mode where one or more predetermined operations related to V2P application are prohibited. For example, the one or more predetermined operations related to V2P application may comprise, but not limited to, at least one of: sending/receiving V2X messages; processing V2X messages; retrieving and sending a global positioning system (GPS) location of the terminal device to a SEAL LMS, etc. With the method of FIG. 9, since the one or more predetermined operations related to V2P application are prohibited, the power consumption of the terminal device can be minimized to allow the terminal device to prolong the time of duration of keeping a connection with its serving network. Since the connection is kept between the terminal device and the serving network, the SEAL LMS can still track the location of the terminal device so that the VASS can send an alert message on behalf of the terminal device, thereby allowing the terminal device to prolong the time of duration of being protected by pedestrian safety system.

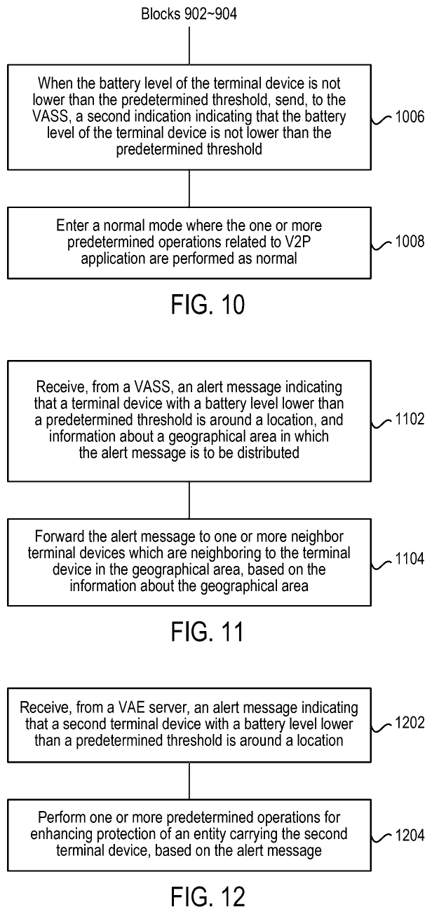

FIG. 10 is a flowchart illustrating a method performed by a terminal device according to an embodiment of the disclosure. As shown, the method comprises blocks 902-904 and blocks 1006-1008. Blocks 902-904 have described above and their details are omitted here. At block 1006, when the battery level of the terminal device is not lower than the predetermined threshold, the terminal device sends, to the VASS, a second indication indicating that the battery level of the terminal device is not lower than the predetermined threshold. For example, the second indication may be implemented by an indicator having a second value. The indicator can take a first value for indicating that the battery level of the terminal device is lower than the predetermined threshold, or the second value for indicating that the battery level of the terminal device is not lower than the predetermined threshold.

At block 1008, the terminal device enters a normal mode where the one or more predetermined operations related to V2P application are performed as normal. As described above, the one or more predetermined operations related to V2P application may comprise, but not limited to, at least one of: sending/receiving V2X messages; processing V2X messages; retrieving and sending a global positioning system (GPS) location of the terminal device to a SEAL LMS, etc. With the method of FIG. 10, more reliable protection can be provided to the terminal device in a case where the battery level of the terminal device is recovered to be normal.

FIG. 11 is a flowchart illustrating a method performed by a VAE server according to an embodiment of the disclosure. At block 1102, the VAE server receives, from a VASS, an alert message indicating that a terminal device with a battery level lower than a predetermined threshold is around a location, and information about a geographical area in which the alert message is to be distributed. For example, the alert message may comprise: information (e.g. identification information) about the terminal device; an indication indicating that the battery level of the terminal device is lower than the predetermined threshold; and information about the location of the terminal device. The indication may be implemented by an indicator having a first value. The indicator can take the first value for indicating that the battery level of the terminal device is lower than the predetermined threshold, or a second value for indicating that the battery level of the terminal device is not lower than the predetermined threshold. The geographical area may be determined by the VASS as described above with respect to block 508.

At block 1104, the VAE server forwards the alert message to one or more neighbor terminal devices which are neighboring to the terminal device in the geographical area, based on the information about the geographical area. Since the VAE server can provide V2X application message distribution capability, the forwarding can be achieved. For example, the way in which the alert message is forwarded may be similar to that described in section 9.4 of 3GPP TS 23.286 V17.4.0. With the method of FIG. 11, it is possible to provide protection to an entity carrying the terminal device even though the terminal device has a low battery level.

FIG. 12 is a flowchart illustrating a method performed by a first terminal device according to an embodiment of the disclosure. For example, the first terminal device may be carried by a vehicle. At block 1202, the first terminal device receives, from a VAE server, an alert message indicating that a second terminal device with a battery level lower than a predetermined threshold is around a location. For example, the alert message may comprise: information (e.g. identification information) about the second terminal device; an indication indicating that the battery level of the second terminal device is lower than the predetermined threshold; and information about the location of the second terminal device. The indication may be implemented by an indicator having a first value. The indicator can take the first value for indicating that the battery level of the terminal device is lower than the predetermined threshold, or a second value for indicating that the battery level of the terminal device is not lower than the predetermined threshold.

At block 1204, the first terminal device performs one or more predetermined operations for enhancing protection of an entity carrying the second terminal device, based on the alert message. For example, the one or more predetermined operations may comprise, but not limited to, one or more of: detecting, around the location indicated by the alert message, a more accurate location of the second terminal device; causing a vehicle carrying the first terminal device to honk when the vehicle is traveling around the location; and causing a vehicle carrying the first terminal device to keep a predetermined distance with the location. The more accurate location of the second terminal device may be detected by one or more of: a radar; a lidar; a video camera; etc. With the method of FIG. 12, it is possible to provide protection to an entity carrying the second terminal device even though the second terminal device has a low battery level.

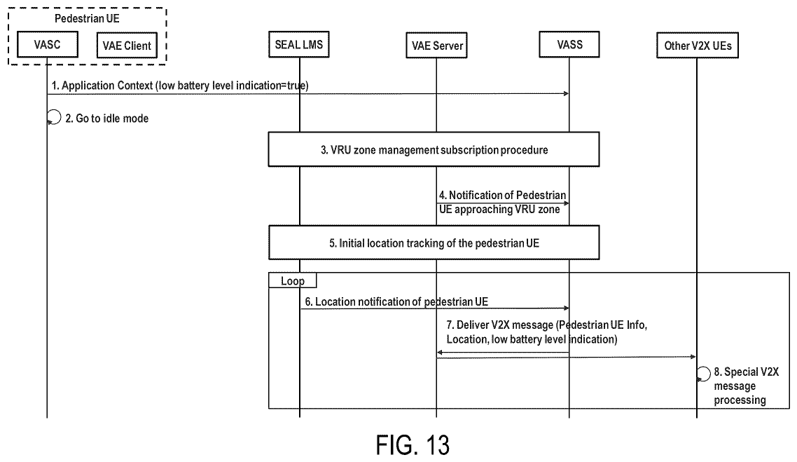

FIG. 13 is a flowchart illustrating an exemplary process according to an embodiment of the disclosure. The process corresponds to the case where the battery level of a pedestrian UE is low. As shown, there are five entities involved in the process: a pedestrian UE, a SEAL LMS, a VAE server, a VASS and other V2X UEs. The pedestrian UE may comprise a V2X application specific client (VASC) and a VAE client. At step 1, the VASC in the pedestrian UE sends application context to the VASS. The application context includes a ‘low battery level indication’ being set to true, which will be sent when the battery level is lower than a predefined threshold. At step 2, the VASC goes to idle mode (e.g., stopping sending/receiving/processing V2X messages and stopping sending GPS locations to SEAL LMS through user plane) to prolong the battery lifetime and keeps connecting with the network (so that the network locations can still work).

At step 3, the VASS may subscribe the VRU zone management provided by the VAE Server. The VAE Server will leverage the SEAL LMS (since the VASC is in idle mode, the SEAL LMS will use the network locations instead) to track the location of the pedestrian UE and detect if the UE is approaching/leaving the VRU zone (see chapter 6.2 of 3GPP TR 23.700-64 V1.0.0). At step 4, the VAE Server alerts the VASS that the pedestrian UE is approaching to (or entering) the VRU zone. At step 5, the VASS requests the SEAL LMS (since the VASC is in idle mode, the SEAL LMS will use network locations instead) to track the location of the pedestrian UE. For tracking the locations of a UE using SEAL, please refer to chapter 9.3.5 “Client-triggered or Vertical Application Layer (VAL) server-triggered location reporting procedure of 3GPP TS 23.434 V18.2.0.

At step 6, the SEAL LMS notifies the network location of the pedestrian UE to the VASS. At step 7, the VASS delivers V2X message (e.g., VRU awareness message (VAM)) on behalf of the pedestrian UE to other relevant V2X UEs, e.g., the nearby vehicles. The VASS delivers the V2X messages by leveraging the V2X application message distribution capability provided by the VAE Server (please refer to chapter 9.4 of V2X message delivery of 3GPP TS 23.286 V17.4.0). The message at least includes pedestrian UE information, the location and a low battery level indication.

At step 8, when other V2X UEs receive the V2X message including the UE information, the location and the low battery level indication, they are aware of that the locations are network locations which may be with lower accuracy and lower reporting frequency. Those V2X UEs may leverage other means to prioritize and compensate the pedestrian detection such as radar/lidar/video camera to ensure the safety of the pedestrian whose UE is on low battery level. As shown, steps 6-8 may be performed iteratively.

In summary, the process described above introduces a method for V2P application on UE (e.g. V2X application specific client, VASC) on low battery level to offload V2X message processing to the server side (the VASS). The VASS can provide downgraded VRU service as long as possible to the VRU for safety. Otherwise, the pedestrian UE will soon run out of battery and disconnect with the network so that the VASS has no chance to provide any VRU service to the VRU.

Specifically, when the VASC finds that the pedestrian UE is on low battery level, it notifies the VASS about this and goes to idle mode, e.g., stops sending/receiving/processing V2X messages to prolong the battery lifetime and keeps connecting with the network. The VASS starts tracking the network location of the pedestrian UE. The VASS sends V2X messages (e.g., VAM) to other relevant V2X UEs based on the retrieved network locations. The other V2X UEs uses special mechanism to process those V2X messages to ensure the safety of the pedestrian. With this method, it can provide downgraded VRU service to VRU for safety as long as possible even though the pedestrian UE is on low battery level.

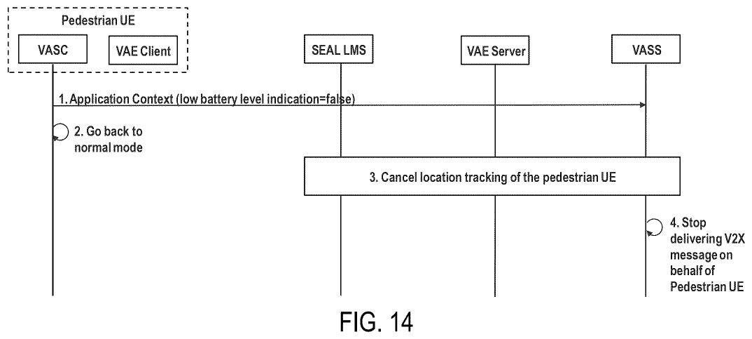

FIG. 14 is a flowchart illustrating an exemplary process according to an embodiment of the disclosure. The process corresponds to the case where the battery level of the pedestrian UE resumes. At step 1, the VASC in the pedestrian UE sends application context to the VASS. The application context includes ‘low battery level indication’ being set to false, which will be sent when the battery level is higher than a predefined threshold. At step 2, the VASC goes back to normal mode (e.g., starting sending/receiving/processing V2X messages locally and starting sending GPS locations to the SEAL LMS through user plane). At step 3, the VASS may cancel location tracking of the pedestrian UE. At step 4, the VASS stops delivering V2X message on behalf on the pedestrian UE.

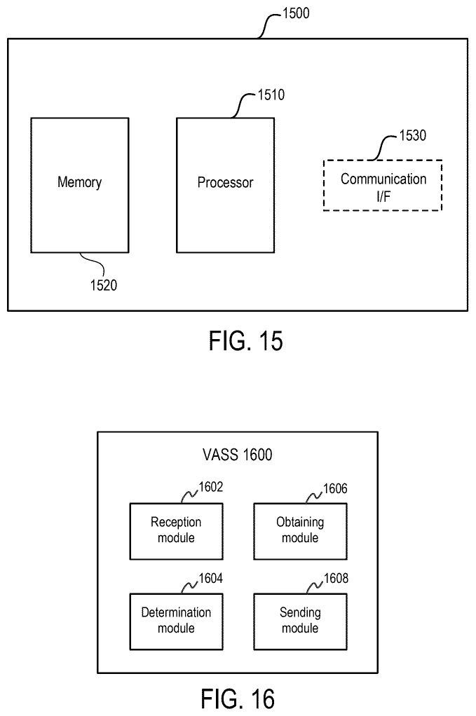

FIG. 15 is a block diagram showing an apparatus suitable for use in practicing some embodiments of the disclosure. For example, any one of the VASS, the terminal device, the VAE server and the first terminal device described above may be implemented through the apparatus 1500. As shown, the apparatus 1500 may include a processor 1510, a memory 1520 that stores a program, and optionally a communication interface 1530 for communicating data with other external devices through wired and/or wireless communication.

The program includes program instructions that, when executed by the processor 1510, enable the apparatus 1500 to operate in accordance with the embodiments of the present disclosure, as discussed above. That is, the embodiments of the present disclosure may be implemented at least in part by computer software executable by the processor 1510, or by hardware, or by a combination of software and hardware.

The memory 1520 may be of any type suitable to the local technical environment and may be implemented using any suitable data storage technology, such as semiconductor based memory devices, flash memories, magnetic memory devices and systems, optical memory devices and systems, fixed memories and removable memories. The processor 1510 may be of any type suitable to the local technical environment, and may include one or more of general purpose computers, special purpose computers, microprocessors, digital signal processors (DSPs) and processors based on multi-core processor architectures, as non-limiting examples.

FIG. 16 is a block diagram showing a VASS according to an embodiment of the disclosure. As shown, the VASS 1600 comprises a reception module 1602, a determination module 1604, an obtaining module 1606 and a sending module 1608. The reception module 1602 may be configured to receive, from a terminal device, a first indication indicating that a battery level of the terminal device is lower than a predetermined threshold, as described above with respect to block 502. The determination module 1604 may be configured to determine whether the terminal device is entering a VRU zone, as described above with respect to block 504. The obtaining module 1606 may be configured to, when determining that the terminal device is entering a VRU zone, obtain a location of the terminal device from a SEAL LMS, as described above with respect to block 506. The sending module 1608 may be configured to send, via a VAE server to one or more neighbor terminal devices which are neighboring to the terminal device, an alert message indicating that the terminal device with the battery level lower than the predetermined threshold is around the obtained location, as described above with respect to block 508.

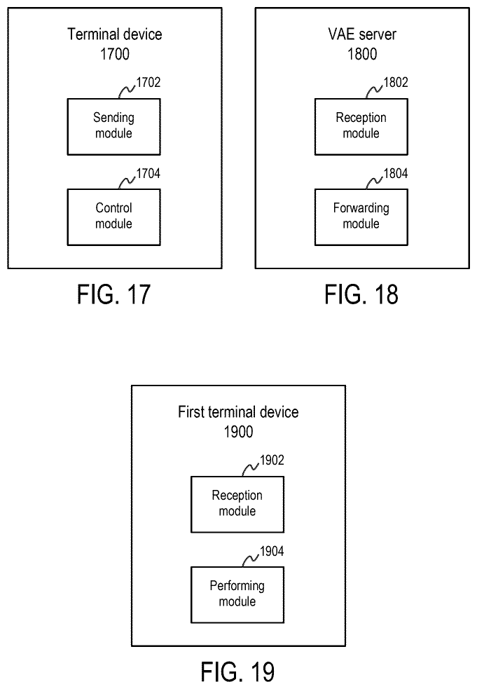

FIG. 17 is a block diagram showing a terminal device according to an embodiment of the disclosure. As shown, the terminal device 1700 comprises a sending module 1702 and a control module 1704. The sending module 1702 may be configured to, when a battery level of the terminal device is lower than a predetermined threshold, send, to a VASS, a first indication indicating that the battery level of the terminal device is lower than the predetermined threshold, as described above with respect to block 902. The control module 1704 may be configured to enter an idle mode where one or more predetermined operations related to V2P application are prohibited, as described above with respect to block 904.

FIG. 18 is a block diagram showing a VAE server according to an embodiment of the disclosure. As shown, the VAE server 1800 comprises a reception module 1802 and a forwarding module 1804. The reception module 1802 may be configured to receive, from a VASS, an alert message indicating that a terminal device with a battery level lower than a predetermined threshold is around a location, and information about a geographical area in which the alert message is to be distributed, as described above with respect to block 1102. The forwarding module 1804 may be configured to forward the alert message to one or more neighbor terminal devices which are neighboring to the terminal device in the geographical area, based on the information about the geographical area, as described above with respect to block 1104.

FIG. 19 is a block diagram showing a first terminal device according to an embodiment of the disclosure. As shown, the first terminal device comprises a reception module 1902 and a performing module 1904. The reception module 1902 may be configured to receive, from a VAE server, an alert message indicating that a second terminal device with a battery level lower than a predetermined threshold is around a location, as described above with respect to block 1202. The performing module 1904 may be configured to perform one or more predetermined operations for enhancing protection of an entity carrying the second terminal device, based on the alert message, as described above with respect to block 1204. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a vehicle-to-everything, V2X, application specific server, VASS, comprising:
receiving, from a terminal device, a first indication indicating that a battery level of the terminal device is lower than a predetermined threshold;
determining whether the terminal device is entering a vulnerable road user, VRU, zone;
when determining that the terminal device is entering a VRU zone, obtaining a location of the terminal device from a service enabler architecture layer, SEAL, location management service, LMS; and
sending, via a V2X application enabler, VAE, server to one or more neighbor terminal devices which are neighboring to the terminal device, an alert message indicating that the terminal device with the battery level lower than the predetermined threshold is around the obtained location.

2. The method according to claim 1, wherein the alert message comprises:
information about the terminal device;
a second indication indicating that the battery level of the terminal device is lower than the predetermined threshold; and
information about the obtained location of the terminal device.

3. The method according to claim 1, wherein the first indication is received in an application context for the terminal device.

4. The method according to claim 1, wherein the first indication is implemented by an indicator having a first value, wherein the indicator can take the first value for indicating that the battery level of the terminal device is lower than the predetermined threshold, or a second value for indicating that the battery level of the terminal device is not lower than the predetermined threshold.

5. The method according to claim 2, wherein the second indication is implemented by an indicator having a first value, wherein the indicator can take the first value for indicating that the battery level of the terminal device is lower than the predetermined threshold, or a second value for indicating that the battery level of the terminal device is not lower than the predetermined threshold.

6. The method according to claim 1, wherein determining whether the terminal device is entering a VRU zone comprises:
sending, to the VAE server, a first request for subscribing to a notification related to whether the terminal device is entering or leaving a VRU zone; and
receiving the notification from the VAE server.

7. The method according to claim 1, wherein obtaining the location of the terminal device from the SEAL LMS comprises:
sending, to the SEAL LMS, a second request for tracking the location of the terminal device; and
receiving, from the SEAL LMS, the location of the terminal device.

8. The method according to claim 1, further comprising:
receiving, from the terminal device, a third indication indicating that the battery level of the terminal device is not lower than the predetermined threshold; and
stopping the obtaining of the location of the terminal device and the sending of the alert message.

9. The method according to claim 8, wherein the third indication is implemented by an indicator having a second value, wherein the indicator can take a first value for indicating that the battery level of the terminal device is lower than the predetermined threshold, or the second value for indicating that the battery level of the terminal device is not lower than the predetermined threshold.

10. A method performed by a terminal device, comprising:
when a battery level of the terminal device is lower than a predetermined threshold, sending, to a vehicle-to-everything, V2X, application specific server, VASS, a first indication indicating that the battery level of the terminal device is lower than the predetermined threshold; and
entering an idle mode where one or more predetermined operations related to vehicle-to-pedestrian, V2P, application are prohibited.

11. The method according to claim 10, wherein the one or more predetermined operations related to V2P application comprise at least one of:
sending/receiving V2X messages;
processing V2X messages; and
retrieving and sending a global positioning system, GPS, location of the terminal device to a service enabler architecture layer, SEAL, location management service, LMS.

12. The method according to claim 10, wherein the first indication is sent in an application context for the terminal device.

13. The method according to claim 10, wherein the first indication is implemented by an indicator having a first value, wherein the indicator can take the first value for indicating that the battery level of the terminal device is lower than the predetermined threshold, or a second value for indicating that the battery level of the terminal device is not lower than the predetermined threshold.

14. The method according to claim 10, further comprising:
when the battery level of the terminal device is not lower than the predetermined threshold, sending, to the VASS, a second indication indicating that the battery level of the terminal device is not lower than the predetermined threshold; and
entering a normal mode where the one or more predetermined operations related to V2P application are performed as normal.

15. The method according to claim 14, wherein the second indication is implemented by an indicator having a second value, wherein the indicator can take a first value for indicating that the battery level of the terminal device is lower than the predetermined threshold, or the second value for indicating that the battery level of the terminal device is not lower than the predetermined threshold.

16. A method performed by a vehicle-to-everything, V2X, application enabler, VAE, server, comprising:
receiving, from a vehicle-to-everything, V2X, application specific server, VASS, an alert message indicating that a terminal device with a battery level lower than a predetermined threshold is around a location, and information about a geographical area in which the alert message is to be distributed; and
forwarding the alert message to one or more neighbor terminal devices which are neighboring to the terminal device in the geographical area, based on the information about the geographical area.

17. The method according to claim 16, wherein the alert message comprises:
information about the terminal device;
an indication indicating that the battery level of the terminal device is lower than the predetermined threshold; and
information about the location of the terminal device.

18. The method according to claim 16, wherein the indication is implemented by an indicator having a first value, wherein the indicator can take the first value for indicating that the battery level of the terminal device is lower than the predetermined threshold, or a second value for indicating that the battery level of the terminal device is not lower than the predetermined threshold.

19. A method performed by a first terminal device, comprising:
receiving, from a vehicle-to-everything, V2X, application enabler, VAE, server, an alert message indicating that a second terminal device with a battery level lower than a predetermined threshold is around a location; and
performing one or more predetermined operations for enhancing protection of an entity carrying the second terminal device, based on the alert message.

20. The method according to claim 19, wherein the one or more predetermined operations comprise one or more of:
detecting, around the location indicated by the alert message, a more accurate location of the second terminal device;
causing a vehicle carrying the first terminal device to honk when the vehicle is traveling around the location; and
causing a vehicle carrying the first terminal device to keep a predetermined distance with the location.

21. The method according to claim 20, wherein the more accurate location of the second terminal device is detected by one or more of:
a radar; a lidar; and a video camera.

22. The method according to claim 19, wherein the alert message comprises:
information about the second terminal device;
an indication indicating that the battery level of the second terminal device is lower than the predetermined threshold; and
information about the location of the second terminal device.

23. A vehicle-to-everything, V2X, application specific server, VASS, comprising:
at least one processor; and
at least one memory, the at least one memory containing instructions executable by the at least one processor, whereby the VASS is operative to:
receive, from a terminal device, a first indication indicating that a battery level of the terminal device is lower than a predetermined threshold;
determine whether the terminal device is entering a vulnerable road user, VRU, zone;
when determining that the terminal device is entering a VRU zone, obtain a location of the terminal device from a service enabler architecture layer, SEAL, location management service, LMS; and
send, via a V2X application enabler, VAE, server to one or more neighbor terminal devices which are neighboring to the terminal device, an alert message indicating that the terminal device with the battery level lower than the predetermined threshold is around the obtained location.

24. (canceled)

25. A terminal device comprising:
at least one processor; and
at least one memory, the at least one memory containing instructions executable by the at least one processor, whereby the terminal device is operative to:
when a battery level of the terminal device is lower than a predetermined threshold, send, to a vehicle-to-everything, V2X, application specific server, VASS, a first indication indicating that the battery level of the terminal device is lower than the predetermined threshold; and
enter an idle mode where one or more predetermined operations related to vehicle-to-pedestrian, V2P, application are prohibited.
